(19) United States
(12) Patent Application Publication
(10) Pub. No.: US 2021/0050676 A1
(43) Pub. Date: Feb. 18, 2021

(54) Method for Estimating a Transmit Signal Channel Quality Indicator Based on a Receive Signal Channel Quality Indicator

(71) Applicant: AVX Antenna, Inc. d/b/a Ethertronics, Inc., San Diego, CA (US)

(72) Inventors: Sebastian Rowson, San Diego, CA (US); Abhishek Singh, San Diego, CA (US)

(21) Appl. No.: 16/991,244

(22) Filed: Aug. 12, 2020

Related U.S. Application Data
(60) Provisional application No. 62/888,013, filed on Aug. 16, 2019.

(51) Int. Cl. H01Q 25/04; H04B 17/309

(52) U.S. Cl. CPC H01Q 25/04; H04W 84/042; H04B 17/309

(57) ABSTRACT

A method for controlling operation of a multi-mode antenna is provided. The multi-mode antenna is configurable in a plurality of modes, and each mode associated with a different radiation pattern or polarization. The method includes receiving, at the multi-mode antenna a first RF signal. The method further obtaining, by one or more control devices, data indicative of a receive signal channel quality indicator for the first RF signal. The method includes configuring, by the one or more control device, the multi-mode antenna for transmitting a second RF signal in a selected mode of the plurality of modes based, at least in part, on the data indicative of the receive signal CQI. The method further includes transmitting, by the multi-mode antenna the second RF signal while the multi-mode antenna is configured in the selected mode.

### PRIORITY CLAIM

The present application claims the benefit of priority of U.S. Provisional App. No. 62/888,013, titled “Method for Estimating a Transmit Signal Channel Quality Indicator Based on a Receive Signal Channel Quality Indicator,” having a filing date of Aug. 16, 2019, which is incorporated by reference herein.

### FIELD

The present disclosure relates generally to devices having a multi-mode antenna and, more particularly, a method for configuring the multi-mode antenna to transmit a transmit radio frequency (RF) signal based, at least in part, on a received signal CQI associated with a received RF signal.

### BACKGROUND

Multi-mode antennas can be used in various applications. For example, multi-mode antennas can be used in a laptop to facilitate communication with other devices, such as other laptops). As another example, altitude-changing objects, such as drones, can include one or more multi-mode antennas to facilitate communication between the altitude-changing objects and one or more nodes within a network (e.g., cellular network). When a device (e.g., smart phone, drone, etc.) having a multi-mode antenna moves relative to other nodes in a network, movement of the device can make it difficult to determine a mode in which the multi-mode antenna should be configured for transmitting a signal to one or more nodes in the network. As such, the multi-mode antenna of the device can, in some instance, be configured in a mode having an antenna radiation pattern that does not effectively minimize interference associated with one or more devices on the network.

### SUMMARY

Aspects and advantages of embodiments of the present disclosure will be set forth in part in the following description, or may be learned from the description, or may be learned through practice of the embodiments.

In one example aspect, a method for controlling operation of a multi-mode antenna is provided. The multi-mode antenna is configurable in a plurality of modes, and each mode associated with a different radiation pattern or polarization. The method includes receiving, at the multi-mode antenna a first RF signal. The method further obtaining, by one or more control devices, data indicative of a receive signal channel quality indicator for the first RF signal. The method includes configuring, by the one or more control device, the multi-mode antenna for transmitting a second RF signal in a selected mode of the plurality of modes based, at least in part, on the data indicative of the receive signal CQI. The method further includes transmitting, by the multi-mode antenna the second RF signal while the multi-mode antenna is configured in the selected mode.

In another example aspect, a system is provided. The system includes a multi-mode antenna configurable to operate in a plurality of modes. Each mode of the plurality of modes has a distinct radiation pattern. The system further includes one or more control devices. The one or more control devices can be configured to obtain data indicative of a receive signal channel CQI for a first RF signal received at the multi-mode antenna. The one or more control devices can be further configured to configure the multi-mode antenna for transmitting a second RF signal in a selected mode of the plurality of modes based, at least in part, on the data indicative of the receive signal CQI.

In yet another example aspect, an altitude changing object is provided. The altitude changing object includes a multi-mode antenna configurable to operate in a plurality of modes. Each of the plurality of modes has a distinct radiation pattern. The altitude changing object further includes one or more control devices. The one or more control devices are configured to obtain data indicative of a receive signal CQI for a first RF signal received at the multi-mode antenna. The one or more control devices are further configured to configure the multi-mode antenna for transmitting a second RF signal in a selected mode of the plurality of modes based, at least in part, on the data indicative of the receive signal CQI.

These and other features, aspects and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE DRAWINGS

Detailed discussion of embodiments directed to one of ordinary skill in the art are set forth in the specification, which makes reference to the appended figures, in which:

FIG. 1 depicts a system according to example embodiments of the present disclosure;

FIG. 2 depicts a multi-mode antenna according to example embodiments of the present disclosure;

FIG. 3 depicts a two-dimensional radiation pattern associated with a multi-mode antenna according to example embodiments of the present disclosure;

FIG. 4 depicts a frequency plot of a multi-mode antenna according to example embodiments of the present disclosure;

FIG. 5 depicts a block diagram of components of a device of the system of FIG. 1 according to example embodiments of the present disclosure;

FIG. 6 depicts a flow diagram of a method for controlling operation of a multi-mode antenna according to example embodiments of the present disclosure;

FIG. 7 depicts an example altitude changing object in a network according to example embodiments of the present disclosure; and

FIG. 8 depicts an example altitude changing object at multiple altitudes in a network according to example embodiments of the present disclosure.

### DETAILED DESCRIPTION

Reference now will be made in detail to embodiments, one or more examples of which are illustrated in the drawings. Each example is provided by way of explanation of the embodiments, not limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations.

Example aspects of the present disclosure are directed to devices having multi-mode antennas. In some implementations, the device (e.g., smartphones, altitude changing object, vehicle, wearable device) can move relative to other devices (e.g., router, cellphone tower, etc.) in a network (e.g., cellular network, 802.11 network, etc.). The multi-mode antenna of the device can be configurable in a plurality of different modes. Each of the plurality of modes can have a distinct radiation pattern or antenna polarization. As will be discussed below, the device can include one or more control devices configured to control operation of the multi-mode antenna.

Movement of the device relative to other devices on the network can impact the ability of the one or more control devices to obtain data indicative of a transmit signal channel quality indicator (CQI) associated with a transmit radio frequency (RF) signal transmitted via the multi-mode antenna. As one example, it can be difficult to obtain data indicative of the transmit signal CQI associated with the transmit RF signal when the multi-mode antenna is implemented on an altitude changing object (e.g., a drone) that is in-flight and positioned above the other devices in the network. As will be discussed below in more detail, the one or more control devices can configure the multi-mode antenna for transmitting the transmit RF signal in a selected mode of the plurality of modes based, at least in part, on data indicative of a receive signal channel quality indicator (CQI) for a receive radio frequency (RF) signal received by the multi-mode antenna.

More particularly, the one or more control devices can be configured to estimate a transmit signal CQI for the transmit RF signal based, at least in part, on the receive signal CQI for the receive RF signal. The one or more control devices can be further configured to determine a selected mode of the plurality of modes based, at least in part, on the estimated transmit signal CQI. In some implementations, the antenna radiation pattern of the selected mode can reduce or minimize interference associated with one or more devices on the network. For example, the antenna radiation pattern of the selected mode can include one or more nulls that are steered towards the one or more devices associated with the interference. In this manner, occurrences of the transmit RF signal being affected by the interference associated with other devices on the network can be reduced or eliminated. In some implementations, areas of high gain associated with the antenna radiation pattern of the selected mode can be steered towards one or more remote devices intended to receive the transmit RF signal. In this manner, communications with the one or more remote devices can be improved.

In some implementations, devices according to the present disclosure can be useful in 802.11 networks in which RF signals are transmitted and received via the same frequency. In this manner, estimating the transmit signal CQI for a transmit RF signal based, at least in part, on a receive signal CQI for a receive RF signal since signals are transmitted and received via the same frequency in the 802.11 networks.

The devices according to example aspects of the present disclosure can provide numerous technical benefits and advantages. For instance, there can be latencies in obtaining transmit signal CQI associated with the transmit RF signal, especially when the device configured to transmit the transmit RF signal is moving relative to other nodes in the network. As such, the one or more control devices according to the present disclosure can be configured to estimate the transmit signal CQI associated with the transmit RF signal based, at least in part, on the receive signal CQI associated with the receive RF signal. In this manner, the one or more control devices can be configured to determine the selected mode of the plurality of modes based, at least in part, on the estimated transmit signal CQI. As such, devices according to example embodiments of the present disclosure can more efficiently determine the selected mode of multi-mode antenna for transmitting the transmit RF signal in situations where data associated with transmit signal CQI is difficult to obtain.

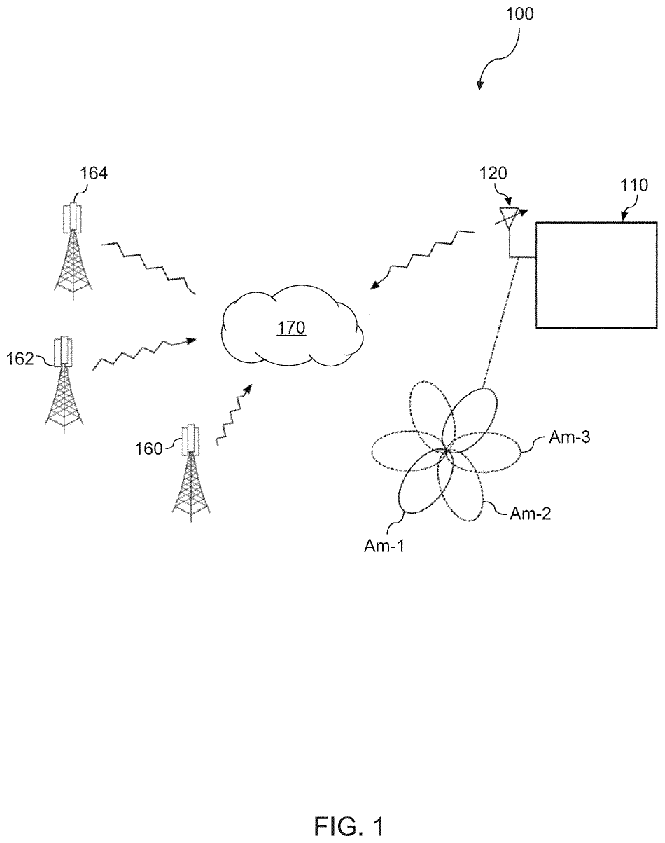

Referring now to the FIGS, FIG. 1 depicts an example system 100 according to example embodiments of the present disclosure. As shown, the system 100 can include a device 110 having a multi-mode antenna 120. In some implementations, the device 110 can be a mobile computing device, such as a smartphone, laptop, tablet, wearable device, etc. In alternative implementations, the device 110 can be an altitude-changing object (e.g., drone). It should be appreciated, however, that the device 110 can include any suitable type of device 110 capable of moving relative to one or more remote devices with which the device 110 is communicating. For instance, in some implementations, the device 110 can be a vehicle.

The multi-mode antenna 120 can be configured to provide beam steering functionality to improve link quality between the device 110 and the one or more remote devices (e.g., router, cell tower, etc.) with which the device 110 is communicating. More particularly, the multi-mode antenna 120 can be configurable in a plurality of antenna modes. Each antenna mode of the plurality of antenna modes can be associated with a different radiation pattern and/or polarization. It should be understood that the device 110 can include any suitable number of multi-mode antennas 120. For instance, in some implementations, the device 110 can include two or more multi-mode antennas.

In some implementations, the multi-mode antenna 120 can be configured in different antenna modes when communicating with the one or more remote devices. For instance, the multi-mode antenna 120 can be configured in a first antenna mode AM-1 to receive and/or transmit one or more RF signals from a first remote device 160 (e.g., cellular tower). The multi-mode antenna 120 can be configured in a second antenna mode AM-2 to receive and/or transmit one or more RF signals from a second remote device 162 (e.g., cellular tower). The multi-mode antenna 120 can be configured in a third antenna mode AM-3 to receive and/or transmit one or more RF signals from a third remote device 164. It should be appreciated that the multi-mode antenna 120 can be configured in any suitable number of different modes.

In some implementations, the multi-mode antenna 120 can communicate with the one or more remote devices via a network 170. It should be appreciated that the multi-mode antenna 120 can be configured to communicate with the one or more remote devices via any suitable type of network 170. For example, in some implementations, the network 170 can be a cellular network. In alternative implementations, the network 170 can be a 802.11 network (e.g., WiFi network) or other wireless local area network (WLAN).

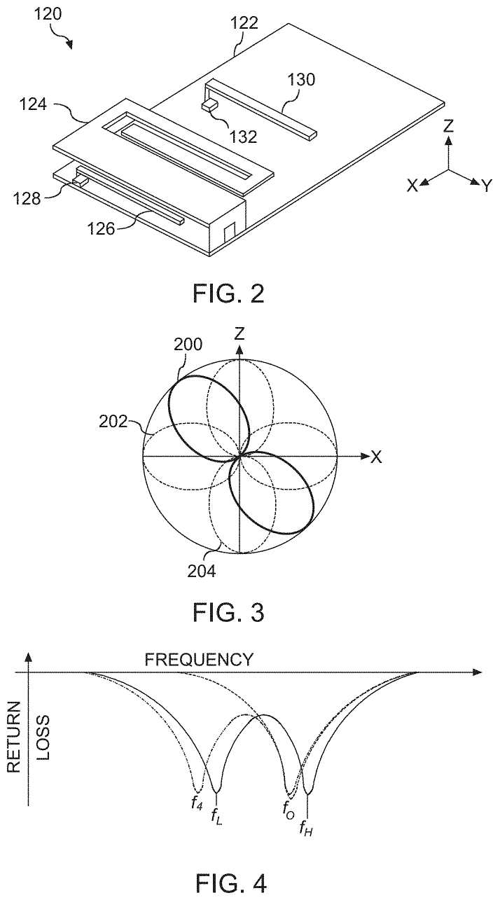

FIG. 2 illustrates an example multi-mode antenna 120 according to the present disclosure. As shown, the multi-mode antenna 120 can include a circuit board 122 (e.g., including a ground plane) and a driven antenna element 124 disposed on the circuit board 122. An antenna volume may be defined between the circuit board 122 (e.g., and the ground plane) and the driven antenna element 124. The multi-mode antenna 120 can include a first parasitic element 126 positioned at least partially within the antenna volume. The multi-mode antenna 120 can further include a first tuning element 128 coupled with the first parasitic element 126. The first tuning element 128 can be a passive or active component or series of components and can be configured to alter a reactance on the first parasitic element 126 either by way of a variable reactance or shorting to ground. It should be appreciated that altering the reactance of the first parasitic element 126 can result in a frequency shift of the multi-mode antenna 120. It should also be appreciated that the first tuning element 128 can include at least one of a tunable capacitor, MEMS device, tunable inductor, switch, a tunable phase shifter, a field-effect transistor, or a diode.

In some implementations, the multi-mode antenna 120 can include a second parasitic element 130 disposed adjacent the driven antenna element 124 and outside of the antenna volume. The multi-mode antenna 120 can further include a second tuning element 132. In some implementations, the second tuning element 132 can be a passive or active component or series of components and may be configured to alter a reactance on the second parasitic element 130 by way of a variable reactance or shorting to ground. It should be appreciated that altering the reactance of the second parasitic element 130 result in a frequency shift of the multi-mode antenna 120. It should also be appreciated that the second tuning element 132 can include at least one of a tunable capacitor, MEMS device, tunable inductor, switch, a tunable phase shifter, a field-effect transistor, or a diode.

In example embodiments, operation of at least one of the first tuning element 128 and the second tuning element 132 can be controlled to adjust (e.g., shift) the antenna radiation pattern of the driven antenna element 124. For example, a reactance of at least one of the first tuning element 128 and the second tuning element 132 can be controlled to adjust the antenna radiation pattern of the driven antenna element 124. Adjusting the antenna radiation pattern can be referred to as “beam steering”. However, in instances where the antenna radiation pattern includes a null, a similar operation, commonly referred to as “null steering”, can be performed to shift the null to an alternative position about the driven antenna element 124 (e.g., to reduce interference).

FIG. 3 depicts antenna radiation patterns associated with the multi-mode antenna 120 of FIG. 1 according to example embodiments of the present disclosure. It should be appreciated that operation of at least one of the first parasitic element 114 and the second parasitic element 118 can be controlled to configure the multi-mode antenna 120 in a plurality of modes. It should also be appreciated that the multi-mode antenna 120 can have a distinct antenna radiation pattern or antenna polarization when configured in each of the plurality of modes.

In some implementations, the multi-mode antenna 120 can have a first antenna radiation pattern 200 when the multi-mode antenna 120 is configured in a first mode of the plurality of modes. In addition, the multi-mode antenna 120 can have a second antenna radiation pattern 202 when the multi-mode antenna 120 is configured in a second mode of the plurality of modes. Furthermore, the multi-mode antenna 120 can have a third antenna radiation pattern 204 when the multi-mode antenna 120 is configured in a third mode of the plurality of modes. As shown, the first antenna radiation pattern 200, the second antenna radiation pattern 202, and the third antenna radiation pattern 204 can be distinct from one another. In this manner, the multi-mode antenna 120 can have a distinct radiation pattern when configured in each of the first mode, second mode, and third mode.

FIG. 4 depicts an example frequency plot of the multi-mode antenna 120 of FIG. 1 according to some aspects of the present disclosure. It should be understood that an electrical characteristic (e.g., reactance) of at least one of the first parasitic element 124 and the second parasitic element 128 can be controlled. In this manner, the electrical characteristic of at least one of the first parasitic element 124 and the second parasitic element 128 can be adjusted to shift a frequency at which the corresponding multi-mode antenna is operating.

In some implementations, the multi-mode antenna 120 can be tuned to a first frequency f₀ when the first parasitic element 126 and the second parasitic element 130 are deactivated (e.g., switched off). Alternatively and/or additionally, the multi-mode antenna 120 can be tuned to frequencies f_{L} and f_{X} when the second parasitic element 130 is shorted to ground. Furthermore, the multi-mode antenna 120 can be tuned to frequency f₄ when both the first parasitic element 126 and the second parasitic element 130 are shorted to ground. Still further, the multi-mode antenna 120 can be tuned to frequencies f₄ and f₀ when the first parasitic element 126 and the second parasitic element 130 are each shorted to ground. It should be understood that other configurations are within the scope of this disclosure. For example, more or fewer parasitic elements may be employed. The positioning of the parasitic elements may be altered to achieve additional modes that may exhibit different frequencies and/or combinations of frequencies.

FIGS. 2-4 depict one example modal antenna having a plurality of modes for purposes of illustration and discussion. Those of ordinary skill in the art, using the disclosures provided herein, will understand that other modal antennas and/or antenna configurations can be used without deviating from the scope of the present disclosure. As used herein a “modal antenna” refers to an antenna capable of operating in a plurality of modes where each mode is associated with a distinct radiation pattern.

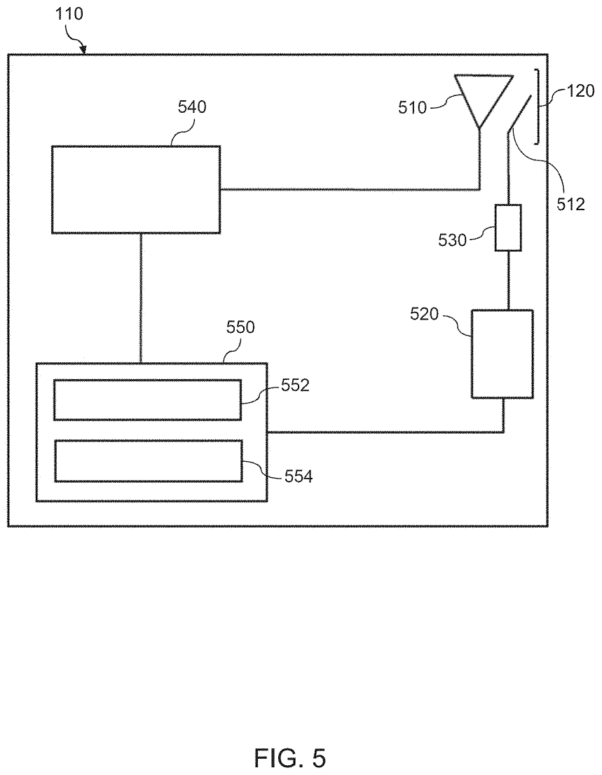

Referring now to FIG. 5, an example embodiment of the device 110 is provided. As shown, the multi-mode antenna 120 can include a driven element 510 and a parasitic element 512. The multi-mode antenna 120 can, as discussed above, be operable in a plurality of different modes. Each mode of the plurality of modes can be associated with a different radiation pattern and/or polarization characteristics, for instance, as described above with reference to FIGS. 2-4. Furthermore, although the device 110 is depicted as having only one multi-mode antenna 120, it should be appreciated that the device 110 can include any suitable number of multi-mode antennas. For instance, in some implementations, the device 110 can include two or more multi-mode antennas.

The device 110 can include a tuning circuit 520 configured to control an electrical characteristic associated with the parasitic element 512 to operate the multi-mode antenna 120 in the plurality of different modes. In some implementations, the device 110 can include a tunable component 530. As shown, the tunable component 530 can be coupled between the parasitic element 512 and the tuning circuit 520. The tuning circuit 520 can be configured to control operation of the tunable component 530 to alter the electrical connectivity of the parasitic element 512 with a voltage or current source or sink, such as coupling the parasitic element 512 to an electrical ground.

The device 110 can include RF circuitry 540. In some implementations, the RF circuitry 540 can include a front end module. The front end module can include, for instance, one or more power amplifiers, low noise amplifiers, impedance matching circuits, etc. In this manner, the front end module can be configured to amplify the RF signal that is transmitted to and/or received from the driven element 510 of the multi-mode antenna 120.

In some implementations, the device 110 can include one or more control devices 550. The one or more control devices 550 can be operatively coupled to the tuning circuit 520. In this manner, the one or more control devices 550 can be configured to control operation of the tuning circuit 520 to configure the multi-mode antenna 120 in the plurality of different modes. Alternatively and/or additionally, the one or more control devices 550 can be in electrical communication with the RF circuitry 540. In this manner, RF signals received at the multi-mode antenna 120 can be provided to the one or more control devices 550 via the RF circuitry 540. In addition, the one or more control devices 550 can provide data to be modulated onto a transmit RF signal provided to the driven element 510 of the multi-mode antenna 120 via the RF circuitry 540.

As shown, the one or more control devices 550 can include one or more processors 552 and one or more memory devices 554. The processor(s) 552 can include any suitable processing device, such as a microprocessor, microcontroller, integrated circuit, logic device, or other suitable processing device. The memory device(s) 554 can include one or more computer-readable media, including, but not limited to, non-transitory computer-readable media, RAM, ROM, hard drives, flash drives, or other memory devices.

The memory device(s) 554 can store information accessible by the processor(s) 552, including computer-readable instructions that can be executed by the processor(s) 552. The computer-readable instructions can be any set of instructions that, when executed by the processor(s) 552, cause the processor(s) 552 to perform operations. The computer-readable instructions can be software written in any suitable programming language or may be implemented in hardware. In some embodiments, the computer-readable instructions can be executed by the processor(s) 552 to cause the processor(s) 552 to perform operations, such as controlling operation of the multi-mode antenna 120.

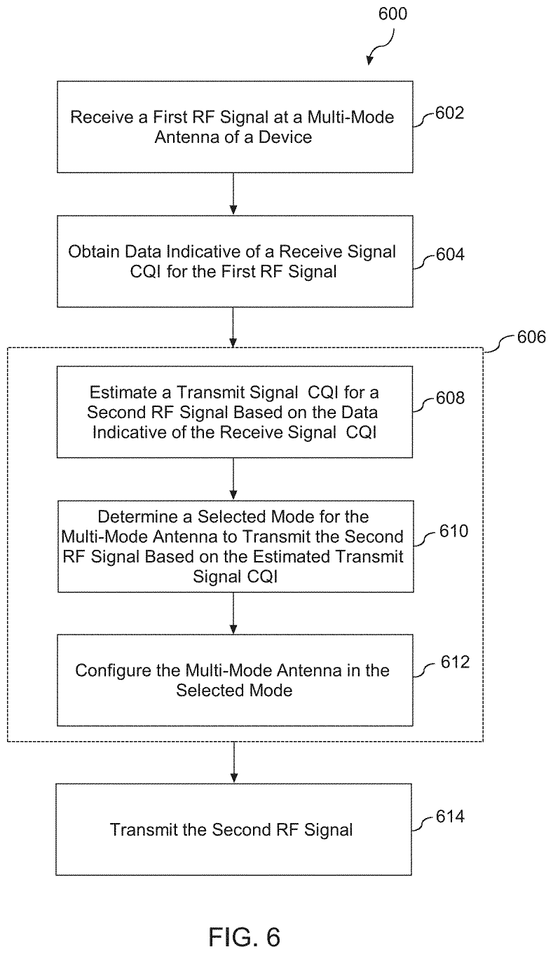

Referring now to FIG. 6, a flow diagram of a method 600 for controlling operation of a multi-mode antenna is provided according to example embodiments of the present disclosure. In general, the method 600 will be discussed herein with reference to the device 110 described above with reference to FIG. 5. In addition, although FIG. 6 depicts steps performed in a particular order for purposes of illustration and discussion, the method discussed herein is not limited to any particular order or arrangement. One skilled in the art, using the disclosure provided herein, will appreciate that various steps of the method disclosed herein can be omitted, rearranged, combined, and/or adapted in various ways without deviating from the scope of the present disclosure.

At (602), the method 600 can include receiving a first RF signal at the multi-mode antenna. At (604), the method 600 can include obtaining, by one or more control devices, data indicative of a receive signal CQI for the first RF signal received at (602). It should be appreciated that examples of data indicative of the receive signal CQI can include at least one of a received signal strength indicator (RSSI), a signal to noise ratio (SNR), a signal to interference plus noise ratio (SNIR), a magnitude error ratio (MER), an error vector magnitude (EVM), a bit error rate (BER), a block error rate (BLER), and a packet error rate (PER) combinations of the foregoing, and/or various other metrics. The CQI can be used to characterize uplink signal quality between a base station and a device having the multi-mode antenna.

At (606), the method 600 can include configuring, by the one or more control devices, the multi-mode antenna for transmitting a second RF signal in a selected mode of the plurality of modes based, at least in part, on the data indicative of the receive signal CQI obtained at (604). In some implementations, configuring the multi-mode antenna for transmitting the second RF signal can include, at (608), estimating, by the one or more control devices, a transmit signal CQI for the second RF signal based, at least in part, on the data indicative of the receive signal CQI obtained at (604). Furthermore, in some implementations, configuring the multi-mode antenna for transmitting the second RF signal in the selected mode can include, at (610), determining, by the one or more control devices, the selected mode of the plurality of modes based, at least in part, on the transmit signal CQI estimated at (608). In addition, configuring the multi-mode antenna for transmitting the second RF signal in the selected mode can include, at (612), configuring the multi-mode antenna in the selected mode determined at (610).

At (614), the method 600 can include transmitting, by the multi-mode antenna, the second RF signal while the multi-mode antenna is configured in the selected mode determined at (610). For instance, in some implementations, transmitting the second RF signal can include transmitting the second RF signal to one or more remote devices. More specifically, the multi-mode antenna can include transmitting the second RF signal over a communications network to the one or more remote devices. It should be appreciated that the network can include any suitable type of network. For example, in some implementations, the network can be a cellular network. As another example, the network can be an 802.11 network.

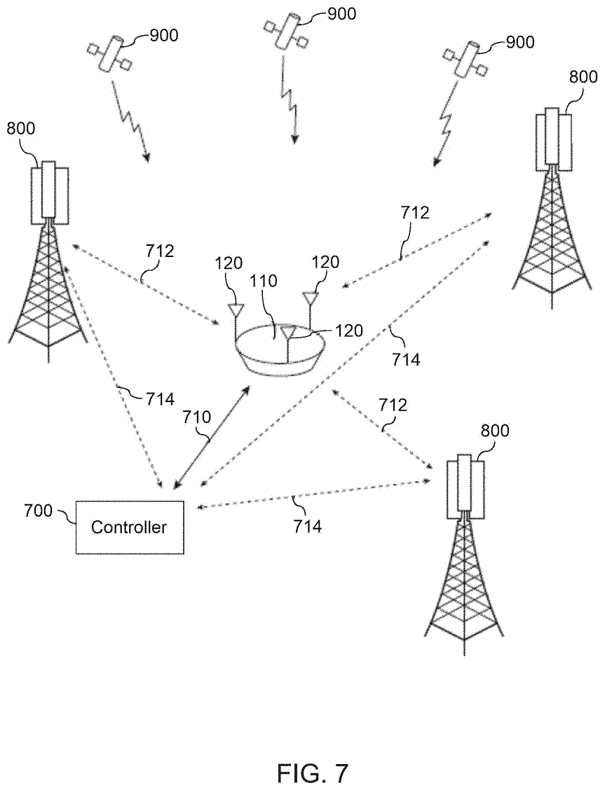

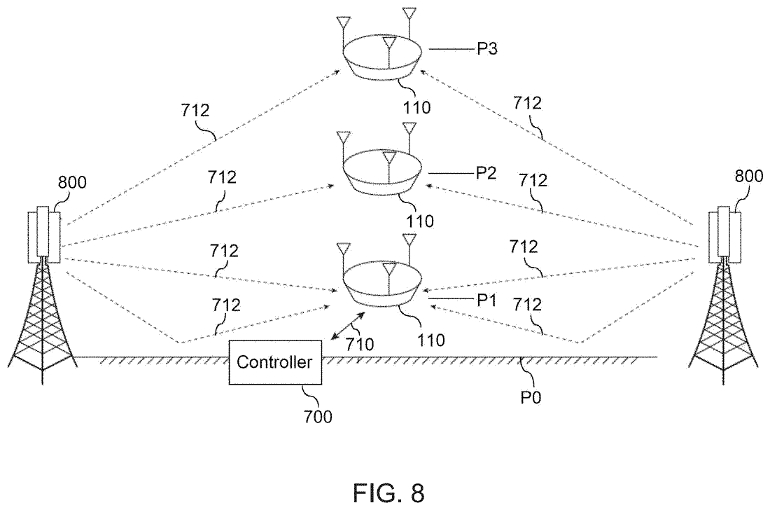

Referring now to FIGS. 7 and 8, the device 110 can, in some implementations, be an altitude-changing object in a network (e.g., cellular network). As shown, the device 110 can include three separate multi-mode antennas 120. It should be appreciated, however, that the device 110 can include more or fewer multi-mode antennas 120. Each of the multi-mode antennas 120 can be in communication with a controller 700 via a first communication link 710. In this manner, the controller 700 can communicate one or more control signals to the one or more multi-mode antennas 120 to control operation of the device 110. For instance, in some implementations, the controller 700 can communicate one or more control signals associated with controlling movement of the device 110.

As shown, a network (e.g., cellular network) is provided that includes a plurality of nodes 800 (e.g., cellular base station terminals). Although the network in the example embodiment depicted only includes three nodes, it should be appreciated that the network can include any suitable number of nodes. As shown, each of the plurality of nodes 800 can be in communication with the device 110 via a second communication link 712. In addition, each of the nodes 800 can be in communication with the controller 700 via a third communication link 714. In this manner, the controller 700 can communicate one or more control signals over the network (e.g., nodes 800) to the one or more multi-mode antennas 120 of the device 110. Alternatively, the controller 700 can, as discussed above, communicate the one or more control signals directly to the device 110 via the first communication link 710.

In some implementations, the network can include global positioning system (GPS) satellites 900 configured to determine a location of the device 110. It should be appreciated that other suitable types of positioning systems can be implemented to determine the location of the device 110. For instance, in some implementations, triangulation systems or dead-reckoning systems can be implemented to determine the location of the device 110. It should be understood that the device 110 can be in communication with the GPS satellites 900 via any suitable communication link.

It should be understood that the multi-mode antennas 120 can receive a RF signal from one or more of the nodes 800 while the device 110 is moving. For example, the multi-mode antennas 120 can receive the RF signal while the device 110 is moving along the vertical direction from the ground P0 to a first position P1, a second position P2, or a third position P3. It should be understood that the device 110 is in-flight (e.g., off the ground) when the device 110 is in each of the first position P1, second position P2, and third position P3.

In such implementations, the controller 700 can obtain data indicative of the receive signal CQI associated with the RF signal received by the multi-mode antennas 120 of the device 110. However, since the device 110 is moving relative to the nodes 800, it should be understood that the controller 700 cannot obtain data indicative of a transmit signal CQI of a transmit RF signal the multi-mode antennas 120 transmit to the one or more nodes 800. In this manner, the controller 700 cannot accurately determine which mode of the plurality of modes the multi-mode antennas 120 need to be configured in when transmitting the transmit RF signal to the one or more nodes 800 such that interference on the network is minimized. As will be discussed below, in more detail, the controller 700 can be configured to determine a selected mode of the plurality of modes for the one or more multi-mode antennas to transmit the transmit RF signal to the one or more nodes 800 based, at least in part, on the data indicative of the receive signal CQI associated with the receive RF signal.

In some implementations, the controller 700 can configure the multi-mode antenna 120 for transmitting the transmit RF signal in a selected mode of the plurality of modes based, at least in part, on the data indicative of the receive signal CQI associated with the receive RF signal. For instance, the controller 700 can estimate a transmit signal CQI associated with the transmit RF signal based, at least in part, on the data indicative of the receive signal CQI associated with the receive RF signal the multi-mode antennas 120 receive from one or more of the nodes 800. Furthermore, the controller 700 can be further configured to select one of the plurality of modes based, at least in part, on the estimated transmit signal CQI associated with the transmit RF signal. As such, the multi-mode antennas 120 can be configured in the selected mode of the plurality of modes while transmitting the transmit RF signal to the one or more nodes 800. In this manner, interference on the network can be reduced or eliminated, because one or more nulls associated with the antenna radiation pattern of the selected mode can be steered towards one or more devices (e.g., nodes 800) associated with interference on the network. In some implementations, areas of high gain associated with the antenna radiation pattern of the selected mode can be steered towards one or more remote devices (e.g., nodes 800) intended to receive the transmit RF signal. In this manner, communications with the one or more remote devices can be improved.

While the present subject matter has been described in detail with respect to specific example embodiments thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. A method for controlling operation of a multi-mode antenna configurable in a plurality of modes, each mode associated with a different radiation pattern or polarization, the method comprising:
receiving, at the multi-mode antenna, a first radio frequency (RF) signal;
obtaining, by one or more control devices, data indicative of a receive signal channel quality indicator (CQI) for the first RF signal;
configuring, by the one or more control devices, the multi-mode antenna for transmitting a second RF signal in a selected mode of the plurality of modes based, at least in part, on the data indicative of the receive signal CQI; and
transmitting, by the multi-mode antenna, the second RF signal while the multi-mode antenna is configured in the selected mode.

2. The method of claim 1, wherein configuring the multi-mode antenna in a selected mode of the plurality of modes based, at least in part, on the data indicative of the receive signal CQI further comprises:
estimating, by the one or more control devices, a transmit signal CQI for the second RF signal based, at least in part, on the data indicative of the receive signal CQI for the first RF signal; and
determining, by the one or more control devices, the selected mode of the plurality of modes based, at least in part, on the transmit signal CQI.

3. The method of claim 2, wherein the data indicative of the receive signal CQI comprises data indicative of at least one of a received signal strength indicator (RSSI), signal-to-noise radio (SNR) and signal-to-interference-plus-noise ratio (SINR).

4. The method of claim 2, wherein the transmit signal CQI comprises at least one of a received signal strength indicator (RSSI), signal-to-noise radio (SNR) and signal-to-interference-plus-noise ratio (SINR).

5. The method of claim 1, wherein transmitting the second RF signal while the multi-mode antenna is configured in the selected mode comprises transmitting the transmit signal over a communications network to one or more remote devices.

6. The method of claim 5, wherein the communications network comprises a cellular network.

7. The method of claim 5, wherein the communications network comprises an 802.11 network.

8. The method of claim 1, wherein the multi-mode antenna is onboard an altitude-changing object.

9. A system, comprising:
a multi-mode active antenna configurable to operate in a plurality of modes, each mode of the plurality of modes having a distinct radiation pattern; and
one or more control devices configured to:
obtain data indicative of a receive signal channel quality indicator (CQI) for a first radio frequency (RF) signal received at the multi-mode antenna; and
configure the multi-mode antenna for transmitting a second RF signal in a selected mode of the plurality of modes based, at least in part, on the data indicative of the receive signal CQI.

10. The system of claim 9 wherein the one or more control devices are further configured to:
estimate a transmit signal CQI for the second RF signal based, at least in part, on the data indicative of the receive signal CQI; and
determine the selected mode based, at least in part, on the transmit signal CQI.

11. The system of claim 10, wherein the data indicative of the receive signal CQI comprises data indicative of at least one of a received signal strength indicator (RSSI), signal-to-noise ratio (SNR) and signal-to-interference-plus-noise ratio (SINR).

12. The system of claim 9, wherein when the multi-mode antenna is configured in the selected mode, the multi-mode antenna is configured to transmit the second RF signal over a communications network to one or more remote devices.

13. The system of claim 12, wherein the communications network comprises a cellular network.

14. The system of claim 12, wherein the communications network comprises an 802.11 network.

15. An altitude changing object, comprising:
a multi-mode antenna configurable to operate in a plurality of modes, each mode of the plurality of modes having a distinct radiation pattern; and
one or more control devices configured to:
obtain data indicative of a receive signal channel quality indicator (CQI) for a first radio frequency (RF) signal received at the multi-mode antenna; and
configure the multi-mode antenna for transmitting a second RF signal in a selected mode of the plurality of modes based, at least in part, on the data indicative of the receive signal CQI.

16. The altitude changing object of claim 15, wherein the one or more control devices are further configured to:
estimate a transmit signal CQI for the second RF signal based, at least in part, on the data indicative of the receive signal CQI for the first RF signal; and
determine the selected mode of the plurality of modes based, at least in part, on the transmit signal CQI.

17. The altitude changing object of claim 15, wherein the data indicative of the receive signal CQI comprises data indicative of at least one of a received signal strength indicator (RSSI), signal-to-noise ratio (SNR) and signal-to-interference-plus-noise ratio (SINR).

18. The altitude changing object of claim 15, wherein when the multi-mode antenna is configured in the selected mode, the multi-mode antenna is configured to transmit the second RF signal over a communications network to one or more remote devices.

19. The altitude changing object of claim 18, wherein the communications network comprises a cellular network.
